(19) United States
(12) Patent Application Publication
(10) Pub. No.: US 2026/0311989 A1
(43) Pub. Date: Oct. 8, 2026

(54) Integrated High Voltage Power Supply and Vacuum Flange for a Mass Spectrometer

(71) Applicant: DH Technologies Development Pte. Ltd., Singapore (SG)

(72) Inventor: Manuel FAUR, Richmond Hill (CA)

(73) Assignee: DH Technologies Development Pte. Ltd., Singapore (SG)

(21) Appl. No.: 19/637,830

(22) Filed: Apr. 2, 2026

Related U.S. Application Data
(60) Provisional application No. 63/783,295, filed on Apr. 4, 2025.

(51) Int. Cl. H01J 49/24; H01J 49/02

(52) U.S. Cl. CPC H01J 49/24; H01J 49/022

(57) ABSTRACT

A mass spectrometer power system is disclosed that includes a vacuum flange configured to be fitted to an opening of a vacuum housing, defining a vacuum chamber, to seal the vacuum chamber from an exterior environment. The vacuum flange includes an exterior surface facing the exterior environment, an interior surface facing the vacuum chamber, and at least one port configured to provide a passageway for at least one electrical conductor. The power system further includes a high voltage power supply (HVPS) circuitry mounted to the vacuum flange on the exterior surface of the vacuum flange and electrically coupled to an end of said at least one electrical conductor extending from the at least one port, and an encapsulant, constructed from a curable insulating encapsulant material, surrounding a segment of said at least one electrical conductor external to said vacuum chamber and at least a part of the HVPS circuitry.

### RELATED APPLICATIONS

This application claims priority to U.S. Provisional Application No. 63/783,295 filed on Apr. 4, 2025, the content of which is incorporated herein by reference in its entirety.

### TECHNICAL FIELD

The present disclosure relates generally to systems and methods for powering a mass spectrometry system, and more particularly to powering components within a vacuum chamber using an integrated vacuum flange and power supply system positioned in close proximity to the vacuum chamber, without needing to deliver power using expensive power cables.

### BACKGROUND

The present disclosure relates generally to systems and methods that allow for safe and efficient operation of power supplies mounted to a structure (e.g., via a vacuum flange) surrounding a vacuum chamber.

Mass spectrometry (MS) is an analytical technique for determining the structures and characteristics of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions needs to occur.

Existing configurations for supplying high voltage to elements within a vacuum chamber(s) of a mass spectrometer use a separated (i.e., non-attached) high voltage power supply (HVPS) module connected to vacuum feedthroughs via shielded cables, with the interior elements in the vacuum chamber connected to the same feedthroughs. Such power cables typically include expensive coaxial high voltage cables and feedthroughs needed for electromagnetic compatibility (EMC) compliance. Furthermore, in fast polarity switching applications such as the high-energy dynode (HED) type detector, there is a limited number of qualified suppliers for the HV coaxial cable assemblies and feedthroughs due to the demanding requirement for corona resistance. Even so, there have been instances of failure of such HV cable assemblies. Consequently, configurations based on the use of such power cables to deliver power from a distant power supply to the vacuum chambers can be unreliable.

### SUMMARY

The solutions and implementations described herein eliminate the shielded HV cable connections between the HVPS and the vacuum feedthroughs, thereby reducing cost and supply risk, improving reliability, and reducing the overall space requirements within analytical instruments. The elimination of HV cables, which typically have high capacitance, also improves the voltage settling time (e.g., in switching mode signal generation, in the number of analysis cycles that can be performed per second, etc.). The proposed solutions allow the positioning of high voltage power supply circuitries (or at least portions of such circuitries) in close proximity to vacuum chambers of MS systems by, for example, directly mounting a high voltage power supply to a vacuum flange (cover) that is hermetically fitted to an opening into the vacuum chamber. The solution also includes using an encapsulant (e.g., a dielectric encapsulant) to cover and protect at least part of the high voltage power supply powering the vacuum chamber, to thereby reduce occurrence of electric discharging events.

Thus, in one aspect, a mass spectrometer power system is provided that includes a vacuum flange configured to be fitted to an opening of a vacuum housing, defining a vacuum chamber of the mass spectrometer, to seal the vacuum chamber from an exterior environment. The vacuum flange includes an exterior surface facing the exterior environment, and an interior surface facing the vacuum chamber. The vacuum flange also includes at least one port configured to provide a passageway for at least one electrical conductor. The mass spectrometer power system further includes a high voltage power supply (HVPS) circuitry mounted to the vacuum flange on the exterior surface of the vacuum flange and electrically coupled to an end of the at least one electrical conductor extending from the at least one port, and an encapsulant, constructed from a curable insulating encapsulant material, surrounding a segment of the at least one electrical conductor external to the vacuum chamber and at least a part of the HVPS circuitry.

In some embodiments, the at least one port of the vacuum flange can include at least one feedthrough to receive said at least one electrical conductor.

In some embodiments, the power system may further include one or more mass spectrometry components positioned in the vacuum chamber.

In some embodiments, the one or more mass spectrometry components may be mounted to the interior surface of the vacuum flange.

In some embodiments, the one or more mass spectrometry components can include one or more of, for example, ion optics components, one or more detector elements, or one or more printed circuit boards.

In some embodiments, the HVPS circuitry may include one or more printed circuit boards (PCB’s) comprising circuitry to receive power from a power source, and to produce high voltage power for application to components within the vacuum chamber via the at least one electrical conductor.

In some embodiments, the encapsulant may include at least one integral vacuum feedthrough, with the one or more integral vacuum feedthroughs being constructed from the insulating encapsulant material, and with the integral vacuum feedthroughs including the at least one conductor passing through the at least one port in the vacuum flange.

In some embodiments, the HVPS circuitry can include at least one printed circuit board (PCB) disposed within the encapsulant.

In some embodiments, the power system may further include an enclosure, coupled to the exterior surface of the vacuum flange, in which the HVPS circuitry is disposed, with the enclosure being one of, for example, a shielding enclosure, or an insulating enclosure.

In some embodiments, the encapsulant may be bonded to at least part of the exterior surface of the vacuum flange and to part of the enclosure.

In some embodiments, the power system may further include an inner container disposed within the enclosure, with the HVPS circuitry being disposed in the container, and with the encapsulant being bonded to at least part of the exterior surface of the vacuum flange and to part of the container.

In some embodiments, the power system can further include a conductive dividing shield within the enclosure separating the encapsulant from at least a part of an inner volume of the enclosure.

In some embodiments, the power system can further include a seal, disposed between the enclosure and the exterior surface of the vacuum flange, to prevent leakage of liquid-form encapsulant material prior to curing of liquid-form of the encapsulant material.

In some embodiments, the HVPS circuitry may include at least one printed circuit board (PCB) disposed within the enclosure but outside the encapsulant.

In some embodiments, the encapsulant may be shaped to substantially conform to a shape of at least a portion of an inner volume of the enclosure in which the encapsulant is disposed.

In some embodiments, the encapsulant may be shaped according to a removable or permanent mold for receiving liquid-form of the encapsulant material, with the mold being disposed in an inner volume of the enclosure and bonded to the vacuum flange.

In some embodiments, the encapsulant may be a dielectric encapsulant.

In some embodiments, the HVPS circuitry may be configured to produce a voltage at a level of at least 2 kV.

In some embodiments, the segment of the at least one electrical conductor can extend from the at least one port of the vacuum flange to the at least part of the HVPS circuitry surrounded by the encapsulant.

In some embodiments, the encapsulant may be shaped according to a removable or permanent mold for receiving liquid-form of the encapsulant material, with the mold surrounding the segment of the at least one electrical conductor external to the vacuum chamber and the at least a part of the HVPS circuitry, and with the exterior surface of the vacuum flange being free of structures surrounding the encapsulant.

In some embodiments, the power system can further include the vacuum chamber defined by the vacuum housing that includes the opening.

In another aspect, a method for coupling a power system to a vacuum chamber of a mass spectrometry (MS) system is disclosed. The method includes mounting a high voltage power supply (HVPS) circuitry to an exterior surface of a vacuum flange that is fittable to an opening of a vacuum housing defining the vacuum chamber of the MS system, with the HVPS circuitry being electrically coupled to an end of at least one electrical conductor, and with the vacuum flange also including at least one port to receive the at least one electrical conductor. The method further includes covering a segment of the at least one electrical conductor external to the vacuum chamber, and at least part of the HVPS circuitry, with an encapsulant constructed from curable insulating encapsulant material, and fitting the vacuum flange with the mounted HVPS circuitry into the opening in the vacuum housing to seal the vacuum chamber from an exterior environment outside of the vacuum chamber, with the exterior surface of the vacuum flange, fitted into the opening in the vacuum housing, facing the exterior environment.

In some embodiments, mounting the HVPS circuitry to the vacuum flange and covering the segment of the at least one electrical conductor and at least part of the HVPS circuitry, may occur prior to the fitting of the vacuum flange into the opening in the vacuum housing.

In some embodiments, the vacuum flange may include an interior surface, opposite the exterior surface, that, when fitted onto the opening in the vacuum housing, the interior surface faces the vacuum chamber.

In some embodiments, covering the segment of the at least one electrical conductor external to the vacuum chamber, and the at least part of the HVPS circuitry with the encapsulant can include pouring liquid form of the of the encapsulant material into a removable or permanent mold to cover the segment of the at least one electrical conductor external to the vacuum chamber and the at least part of the HVPS circuitry.

In some embodiments, mounting the HVPS circuitry to the vacuum flange may include mounting an enclosure for housing the at least one electrical conductor and the HVPS circuitry to the exterior surface of the vacuum flange.

In some embodiments, covering the segment of the at least one electrical conductor external to the chamber and at least part of the HVPS circuitry with the encapsulant may include pouring liquid form of the encapsulant material into an inner volume of the enclosure containing the segment of the at least one electrical conductor external to the vacuum chamber and the at least part of the HVPS circuitry.

In some embodiments, mounting the HVPS circuitry to the exterior surface of the vacuum flange may include mounting the HVPS circuitry to the exterior surface of the vacuum flange and covering at least a portion of the HVPS circuitry with an encapsulant to form an exterior assembly, and fitting the exterior assembly to the opening defined in the vacuum housing.

Further understanding of various aspects of the present teachings can be obtained by reference to the following detailed description in conjunction with the associated drawings, which are described briefly below.

### BRIEF DESCRIPTION OF THE DRAWINGS

FIG. 1 is a cross-sectional schematic diagram of a power system that includes an example integrated high voltage power supply (HVPS) and vacuum flange assembly that is fittable onto an opening of a vacuum chamber.

FIG. 2 is a schematic diagram an example power system placed inside an enclosure into which encapsulant material can be introduced.

FIG. 3 is a schematic diagram of an example mass spectrometry (MS) system in which integrated HVPS and vacuum flange assemblies are used in conjunction with one or more vacuum chambers of the MS system.

FIG. 4 is a flowchart of an example procedure for coupling a power system to a vacuum chamber of a mass spectrometry system.

### DETAILED DESCRIPTION

It will be appreciated that for clarity, the following discussion will explicate various aspects of embodiments of the applicant’s teachings, while omitting certain specific details wherever convenient or appropriate to do so. For example, discussion of like or analogous features in alternative embodiments may be somewhat abbreviated. Well-known ideas or concepts may also, for brevity, not be discussed in any great detail. The skilled person will recognize that some embodiments of the applicant’s teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant’s teachings in any manner.

As used herein, the terms "about" and "substantially equal" refer to variations in a numerical quantity that can occur, for example, through measuring or handling procedures in the real world; through inadvertent error in these procedures; through differences in the manufacture, source, or purity of compositions or reagents; and the like. Typically, the terms "about" and "substantially" as used herein means 10% greater or less than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term "and/or" includes any and all combinations of one or more of the associated listed items and may be abbreviated as "/". Although some aspects have been described in the context of an apparatus, it is clear that these aspects also represent a description of the corresponding method, where a block or device corresponds to a method step or a feature of a method step. Analogously, aspects described in the context of a method step also represent description of a corresponding block or item or feature of a corresponding apparatus. Some or all of the method steps may be executed by (or using) a hardware apparatus, like for example, a processor, a microprocessor, a programmable computer, or an electronic circuit. In some embodiments, some one or more of the most important method steps may be executed by such an apparatus.

The term “component of a mass spectrometer” refers to a device, unit, section, and/or sub-assembly associated with the mass spectrometer. Some examples of a component of a mass spectrometer can include, without limitation, an ion guide, a mass filter, a mass analyzer, etc.

The present disclosure is generally related to improved methods, systems, and devices for powering mass spectrometry (MS) systems, and in particular powering of MS components in vacuum chambers (in which gas pressure is lower than ambient pressure). Under the proposed solution, at least part of a high voltage power supply (HVPS) system is mounted on the outside (exterior surface) of a flange/cover of a vacuum chamber. To avoid the risk a corona discharge (an electrical discharge caused by the ionization of a fluid such as air surrounding a conductor to which high voltage is applied) resulting from the high voltage operation of the HVPS (which could damage the vacuum chamber, or create considerable measurement noise), at least some parts of the HVPS are encased in an encapsulant. Such an encapsulant can be, in some embodiments, poured in liquid form into a mold that contains the HVPS parts to be encased, and is then hardened to a solid state that encases the HVPS parts. The encapsulant can also be bonded to the vacuum flange during the encapsulant curing process, thus improving the strength and durability of the integrated assemblies described herein. Electric conductors (not necessarily HV cables) connect the output of the HVPS to the components within the vacuum chamber (optionally via HV vacuum feedthroughs). The encapsulant used to encase and electrically insulate a portion of the HVPS (while allowing the electrical circuits encased with the encapsulant to continue operating) also covers at least part of the electrical conductors extending from the HVPS circuitry to ports on the flange that provide a passageway into the interior of the vacuum chamber being powered by the HVPS.

As will be discussed in greater detail below, implementations of the integrated HVPS and vacuum flange assembly include a vacuum flange (also referred to as a chamber cover) with provisions for mounting the flange directly to an opening in a vacuum chamber and forming a vacuum seal to the chamber, one or more HV electrical ports through which electrical conductors can pass (such ports that can be fitted with feedthroughs secured to the flange or to the ports), high voltage power supply circuitry (that may include one or more printed circuit boards), forming at least part of the HVPS, with the HVPS circuitry mounted to the flange, and insulating encapsulant material surrounding at least a portion of the high voltage power supply circuitry (optionally bonded to at least part of the air side of the vacuum flange).

The assembly can also include a shielding enclosure mounted to the flange in which the high voltage power supply circuitry is disposed. In such embodiments, the encapsulant can also be bonded to at least part of the enclosure (to further strengthen the structural integrity of the assembly). The high voltage power supply circuitry can include one or more printed circuit boards forming at least part of the HVPS. One or more of the circuit boards can be disposed inside the enclosure, but outside the encapsulant. Alternatively, the PCBA’s can partly be surrounded by the encapsulant. The assembly can include a conductive dividing shield within the enclosure. The assembly can also include additional means of containing the encapsulant within the enclosure, such that the encapsulant bonds to the containing means (e.g., an inner container with the enclosure) instead of to the outer enclosure.

In various examples, the encapsulant can be formed using a removable mold such that it is only bonded to the vacuum flange (to reduce weight). The enclosure may be either an insulating enclosure or a shielding enclosure (the walls of the enclosure may, in some embodiments, include multiple layers to achieve both insulating and shielding functionality). The assembly can further include a seal between the enclosure and the vacuum flange (e.g., the exterior surface of the flange) to prevent leakage of the liquid encapsulant prior to curing. The assembly can include integrated electrical vacuum feedthroughs formed using the encapsulant instead of using separate feedthrough parts. In various embodiments, ion optics, detector elements, or PCBA’s can be directly mounted to the vacuum side of the flange and connected to the conductors extending through the ports (or the feedthroughs, if the feedthroughs are included with the assembly).

The frameworks and implementations discussed herein can thus provide a more compact, space-efficient (increasing the hardware density near the MS sections, thus reducing the volume of a deployed MS system), and cost-effective assembly for supplying power to components of MS systems. The proposed solutions also eliminate the use of bulky, expensive high voltage power cables (known to suffer from a degree of unreliability), and instead use more common electric cables, wires, conductors, or pins. In addition, the proposed frameworks and implementations realize a safer solution for providing high voltage power to components of an MS system by encasing electrical parts that are prone to electrical discharge using an easy-to-deploy insulating encapsulant that electrically insulates the high voltage components of the power supply system from fluids and gasses, while allowing the high voltage power system to maintain normal power operations.

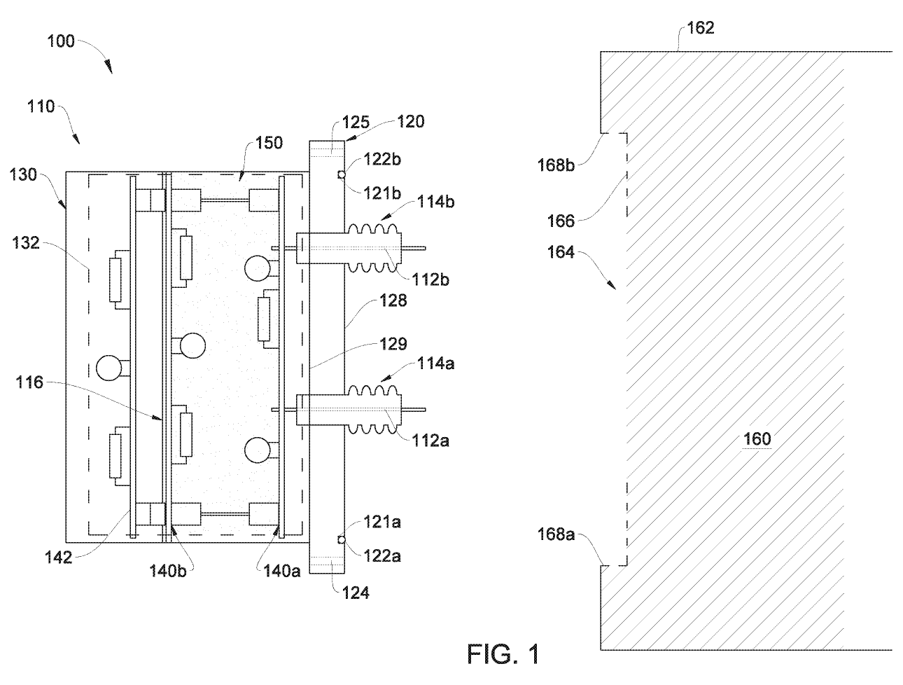

More specifically, implementation of the proposed framework and solutions are described with reference to FIG. 1, showing a cross-sectional schematic diagram of a system 100 that includes an example integrated HVPS and vacuum flange assembly 110 that is fittable into an opening 164 defined by a housing 162 of a vacuum chamber 160. The assembly 110 seals the vacuum chamber to allow vacuum conditions to form inside the chamber 160, while positioning at least part of the high voltage power system needed to power the components inside the chamber (e.g., ion guide components, ion trap component, components of some other analytical system, etc.) at close proximity to the vacuum chamber 160. In the embodiments depicted in FIG. 1, at least part of a high voltage power system (HVPS) circuitry (represented as printed circuit board assemblies 140a-b and 142) are mounted within an enclosure (e.g., housing) 130 that is mounted to the exterior part of a flange 120 that is fitted into the opening 164.

At least part of the circuitry within the enclosure 130 is encased (encapsulated) in an encapsulant 150 that is constructed from an insulating encapsulant material. The HVPS may include other modules, such as an external power source and relay nodes, not illustrated in FIG. 1, which may be positioned remotely from the system 100, and which may be used to serve other components / sections of the MS system. The encapsulant 150 may have been constructed by pouring the liquid form of the insulating (dielectric) encapsulant material into a mold, or pouring the liquid encapsulant material directly into the enclosure 130 in which the HVPS circuitry is disposed, effectively using the volume defined by interior walls of the enclosure 130 to act as a mold. Examples of suitable insulating (dielectric) encapsulant materials that can be introduced, during the manufacturing process, in liquid form, and that harden into a desirable shape defined by a mold or the inner volume of the enclosure, include epoxy, silicone, urethane, and acrylic encapsulant materials. In some embodiments, to strengthen the bond between the hardening encapsulant and the internal surfaces to which the encapsulant is to bond, a primer material can initially be used to coat those internal surfaces that will come in contact with the encapsulant. Subsequent introduction of the liquid encapsulant will result, upon the hardening of the encapsulant material, in a strong bond between the bonding surfaces and the encapsulant.

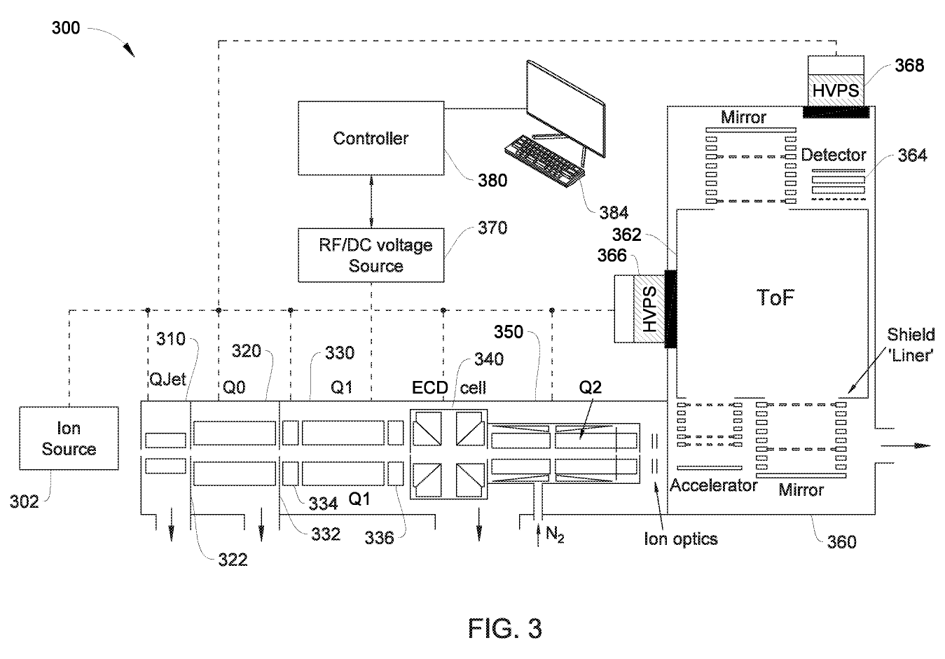

As noted, the integrated HVPS and vacuum flange assembly 110 includes the flange (or cover) 120 dimensioned and shaped to fit into an opening 164 of the housing 162 that defines the interior of the vacuum chamber 160. The vacuum chamber can house a section(s) of the analytical system (in this case, a mass spectrometry system) that needs to operate within a vacuum. Examples of sections that that may be operated in a low pressure environment include an MS system ion source, one or more ion guides, ion dissociation sections (e.g., collision cells), ion traps, mass analyzers, etc. To the extent that one or more of the sections of the MS system need to operate in a vacuum, each such section may be equipped with one or more vacuum pumps to provide the required vacuum levels within those sections. Assemblies such as the assembly 110 can be used to seal one or more of the vacuum chambers while delivering high voltage power (RF and/or DC) in a safe and efficient manner to the MS components (be it ion guides, ion dissociation units, etc.) housed within the housings defining the vacuum chamber. In some embodiments, vacuum differentials can be created between certain elements of mass spectrometer system. An example implementation of a mass spectrometry system, in which integrated HVPS and vacuum flange assemblies (such as the assembly 110) are used in conjunction with one or more vacuum chambers of the MS system, is more fully discussed in relation to FIG. 3. It is noted that in some embodiments, the vacuum chamber 160 may be considered to be part of the overall power system, while in other embodiments, the assembly 110 comprising the flange, the power supply circuitry, and the encapsulant covering at least part of the power supply circuitry constitutes the power supply system (i.e., excluding the vacuum chamber 160).

The vacuum flange 120 is generally constructed from durable materials, usually the same or one compatible with the materials from which the housing 162, defining the vacuum chamber 160, is made. Examples of suitable materials to construct the flange 120 and/or the housing 162 include aluminum and stainless-steel. As further shown in FIG. 1, the vacuum flange 120 includes a vacuum seal such as an O-ring (annular ring) or other type of gaskets (in the cross-section diagram of the assembly 110, two diametrically opposed cross-sectional surfaces 122a and 122b of the seal are shown) that is snugly fitted within seal grooves (represented as diametrically opposed groove points 121a and 121b) defined on the inner surface 128 the flange 120 (i.e., the surface that faces the vacuum chamber when the flange is fitted into the opening 164). The seal grooves are dimensioned such that at least part of the vacuum seal protrudes from the grooves and can be fitted within receiving grooves of a complementary structure with which the seal is to be formed (in this case a structure associated with the vacuum chamber 160). The vacuum seal is constructed from an elastic material that pushes against other surfaces that come in contact with it. Alternatively, the vacuum seal may be some other resilient structure (a hollow tube or collar, such as one made from Teflon-type materials, with a metal spring that pushes against inner walls of the hollow structure) that then presses on the surfaces with which the seal ring comes in contact with.

To seal the vacuum chamber, the flange 120, on which the high voltage power system circuitry is mounted, is pressed into, and snugly fitted within the opening 164 of the housing 162. The vacuum seal (represented by its diametrically opposed cross-sectional surfaces 122a and 122b) may optionally be placed into complementary receiving grooves that may be defined within a rim or shelf structure 166 (depicted in cross-section with dashed lines) extending from the edges of the housing 162 defining the opening 164. That is, as the flange 120 is pressed down into the opening, it will (in this example embodiment) come to rest on the rim / shelf 166 extending from the edges of the opening defining the opening 164. The vacuum seal portion protruding from the groove on the interior surface 128 (represented by the surfaces 122a and 122b) of the flange is fitted and received by the complementary receiving grooves defined on the rim / shelf in the housing 162. As a result, the previously protruding seal portion fitted within the receiving grooves of the shelf 166, together with the snug fit between end sections 124 and 125 of the flange 120 and edge walls 168a and 168b defining the opening 164 of the housing 162, create a strong vacuum seal to prevent / inhibit entry of fluids (gases or liquids) into the vacuum chamber. To further fortify the sealing created using the flange and vacuum seal, various locking mechanisms to further fasten the flange 120, placed in the opening 164, to the housing 162 may be used.

The flange 120 further includes one or more ports, typically extending from an exterior surface 129 to the interior surface 128, through which one or more electrical conductors 112a and 112b pass, connecting the output of the high voltage power supply circuitry mounted on the flange 120 to components within the vacuum chamber 160. Unlike conventional high voltage power cables configured to carry power from relatively remote power supplies to the destination loads (e.g., MS components) through unpredictable environments, in the framework of FIG. 1, the electrical conductors delivering power into the vacuum chamber have to traverse a relatively short distance through a controlled environment. For example, the environment in which the electrical conductors (such as the conductors 112a and 112b) are disposed includes an insulating encapsulant 150 covering, at least partly, the one or more electrical conductors (and also covering at least a portion of the HVPS circuitry). Such an implementation reduces the risks that are otherwise present when delivering high voltage power to components requiring such power (e.g., electrode rods of ion guides).

In some embodiments, the ports in the flange 120 through which the one or more electrical conductors pass may include insulating feedthroughs. For example, in some embodiments, elastic feedthroughs, such as feedthroughs 114a and 114b, can be fitted through the ports, and resiliently expand to press against the interior walls of the ports of the vacuum flange 120, thus further insulating the path of the electrical conductors. In some examples, feedthrough insulators that are rigid and sealed with O-rings or gaskets can be included with the ports. In some embodiments, when fitting feedthroughs into the ports, liquid encapsulant can be used to seal the feedthroughs (by allowing the liquid encapsulant to trickle in spacing between the walls of the ports and the outer walls of the feedthroughs), while ensuring that the liquid encapsulant does not leak through the threads of the feedthroughs. The use of liquid encapsulant to create a seal for the feedthroughs can remove the need to use O-rings or gaskets to create the seal. Alternatively, in some embodiments, the feedthrough 114a and 114b can be formed using the encapsulant material used to form the encapsulant 150. For example, at the time of assembling or manufacturing of the integrated HVPS and vacuum flange assembly, feedthrough molds (that may be removed or dissolved after use, and/or which may be part of the mold for encasing the HVPS circuitry) can be fitted into the ports of the flange, and upon the introduction of liquid-form encapsulant material, some of the material would be directed into the feedthrough molds. In embodiments in which integral vacuum feedthroughs are used, the integral vacuum feedthroughs include the at least one conductor passing through the at least one port in the vacuum flange.

With continued reference to FIG. 1, as noted, at least part of an HVPS system can be mounted or fixed to an individual flange for dedicated use with a particular section of an analytical system (e.g., mass spectrometer). Thus, in some embodiments, another part of the HVPS system may be a common central HVPS part shared by several MS sections. For example, a central HVPS system, not mounted directly to any particular section, can receive power from an external source, optionally perform some voltage conversion operations, and then feed the resultant output to multiple local HVPS circuitries (such as the circuitry depicted in FIG. 1) dedicated to power respective systems / sections. Alternatively, the entirety of a HVPS system may be implemented for use by a particular system or system section. The HVPS circuitry of FIG. 1 can include power management circuitry comprising passive electrical components (e.g., capacitors, resistors, inductors, coiled transformers, etc.) and active electrical components such as switching devices, processor-based devices, etc. For example, the active switching devices can include transistors to implement switch-mode voltage control through actuation of the switching devices based on tracking of computed errors between a desired voltage level and an actual voltage level. The high voltage power supply system can also include power amplifiers (e.g., a pulse width modulation driver, and/or other types of power amplifiers). The various power generation and power management components that implement the HVPS circuitry can be arranged, for example, on one or more printed circuit board assemblies, such as the PCBA 140a-b (which are illustrated as being encased in an encapsulant) and PBCA 142.

In some examples, one or more PCBA’s may be secured to the exterior surface 129 of the flange 120 through various fastening mechanisms (e.g., screws or standoffs), adhesives, soldering processes, and so on. A support structure (such as a frame; not shown) may be affixed to the flange 120, and thereafter PCBA’s may be secured to the support structure and/or to earlier secured PCBA’s. For example, in the embodiments of FIG. 1, the PCBA 140b, is seen secured to the PCBA 140a, which is the structure closest to the exterior surface 129 of the flange 120. While the diagram 100 shows the PCBA’s disposed within the enclosure 130, the PCBA’s could have been mounted by using a support structure placed on the flange 120. Additionally and/or alternatively, the PCBA’s could have been mounted on to the flange 120 by placing the PCBA’s on a removable mold resting on the exterior surface 129, and pouring liquid encapsulant material into the removable mold (it is important to ensure that the liquid encapsulant does not have air bubbles that could result in the formation of air voids within the hardened encapsulant). Upon the hardening of the encapsulant material, and removal of the mold, the PCBA’s would be supported by, and secured to the flange 120, through the hardened encapsulant material. However, as noted, in the example arrangement depicted in FIG. 1, the PCBA’s are disposed within the enclosure 130 that can be secured (e.g., through a combination of fastening mechanisms, adhesives, the bonding formed through use of the encapsulant material, etc.) to the flange 120. Thus, in the former implementation (where the mold, and subsequently the hardened encapsulant, provide the supporting structure on which to mount and/or bond the HVPS circuitry to the exterior surface of the flange), the encapsulant can be shaped according to a removable or permanent mold used for receiving liquid-form of the encapsulant material, with the mold surrounding the segment of the at least one electrical conductor external to the vacuum chamber and the at least a part of the HVPS circuitry, and with the exterior surface of the vacuum flange being free of other structures surrounding the encapsulant and/or mold.

With continued reference to FIG. 1, a conductive divider 116 may be placed across at least some of the HVPS circuitry to shield the HVPS circuitry from electrostatic, and prevent external electrical activity such as electrical surges, electromagnetic interference, etc. In the diagram 100 of FIG. 1, the conductive divider 116 may be a conductive plate extending from one wall of the enclosure 130 to the opposite side wall to electrically divide (and thus shield from external electrical and electromagnetic activity) the portion of the HVPS circuitry (e.g., the PCBA’s 140a-b) that are covered with the encapsulant 150. The PCBA 142 includes electrical connectors to electrically connect the PCBA 142 to the PCBA 140b that may pass through openings within the conductive divider (thus creating an electrical path between the shielded and non-shielded parts of the HVPS circuitry mounted on the flange. While not shown in the cross-sectional schematic diagram of FIG. 1, the conductive divider 116 may be a plate-shaped conductive divider that covers and encloses the bottom volume of the assembly 110 occupied by the portion of the HVPS circuitry encased in the encapsulant 150. The conductive shield can be constructed with one or more encapsulant pouring ports that would allow for the introduction of curable liquid encapsulant into the bottom volume occupied by the portion of the HVPS circuitry that is to be encased with an encapsulant. Such a configuration, that includes encapsulant-pouring ports, can be used in situations where the HVPS circuitry is pre-fabricated with the conductive shielding already placed to separate portions of the HVPS circuitry. In that situation, the pre-fabricated HVPS circuitry can be first mounted to the flange 120, and the liquid encapsulant is then subsequently introduced into the portion of the circuitry that is to be encased with the encapsulant. Alternatively, the portion of the HVPS circuitry to be encased with the encapsulant can first be mounted onto the flange 120, the liquid encapsulant can then be poured directly into the exposed HVPS circuitry (the liquid encapsulant can be poured into a mold, or into the enclosure, or some other holding device, that defines the boundaries and contours of the encapsulant), and the conductive shield can then be placed on the hardening encapsulant (any non-encased portions of the HVPS circuitry can subsequently be mounted on the conductive shield, or alternatively the shield and non-encased HVPS circuitry could have been pre-fabricated as a single module that is placed on the hardening encapsulant).

In some implementations, the assembly 110 can further include an inner container 132 (schematically illustrated using dashed and dotted lines) that is constructed from conductive shielding materials or from dielectric insulating materials. In such implementations, the at least the portion of the HVPS circuitry that is to be encapsulated may be disposed within the inner volume of the inner container, to create a double barrier between the external environment and the HV power generation and delivery functionality that would be operating within the container 132. For example, the inner container in which the HVPS circuitry (or a portion thereof) is disposed can be constructed from a conductive shielding material (the container can include multiple layers, with one layer being an insulator, and another layer can be a conductive shielding layer), while the outer enclosure 130 can be constructed from an electrically insulating material. This arrangement can be reversed, with the outer enclosure constructed from a shielding material, while the walls of the inner container may be constructed from insulating materials. Use of such multiple concentric enclosures / container (and/or use of multi-layered walls for the enclosing / holding structures) can thus provide the assembly both electrically insulating and electrical shielding functionality. The multi-container configuration can also provide additional physical protection for sensitive and potentially fragile electrical components, and may also require less encapsulant material to be used. In implementations that include an inner container such as the container 132, the encapsulant material that is used to encase at least part of the HVPS circuitry (and cover segments of electrical conductors connecting the output of the HVPS circuitry to the electrical connections at the flange 120) may be bonded to at least part of the exterior surface of the vacuum flange and to part of the container 132.

FIG. 1 illustrates one example configuration of the HVPS circuitry mounted to the exterior surface of the vacuum flange. As noted, in this example configuration PCBA’s holding the active and passive components to perform high voltage conversion (with the circuitry configured to produce voltage at a level of at least 2 kV) are stacked, with some of the PCBA’s (e.g., the PCBA’s 140a-b) encased with insulating dielectric, and with one or more PCBA’s mounted (stacked) outside the encapsulant (and optionally separated from the encased PCBA’s with a conductive shield). As noted, in this example configuration, the PCBA’s and the conductive shield (if one is used) could have been mounted prior to pouring liquified insulating encapsulant material, in which case the liquified encapsulant material could have been poured through openings defined in the conductive shield. Alternatively, in this configuration, the shield and non-encased PCBA’s (and/or electrical components not arranged on PCBA’s) are mounted after the liquified encapsulant material had been poured into the volume containing the PCBA’s to be encased and had an opportunity to harden (at least partially).

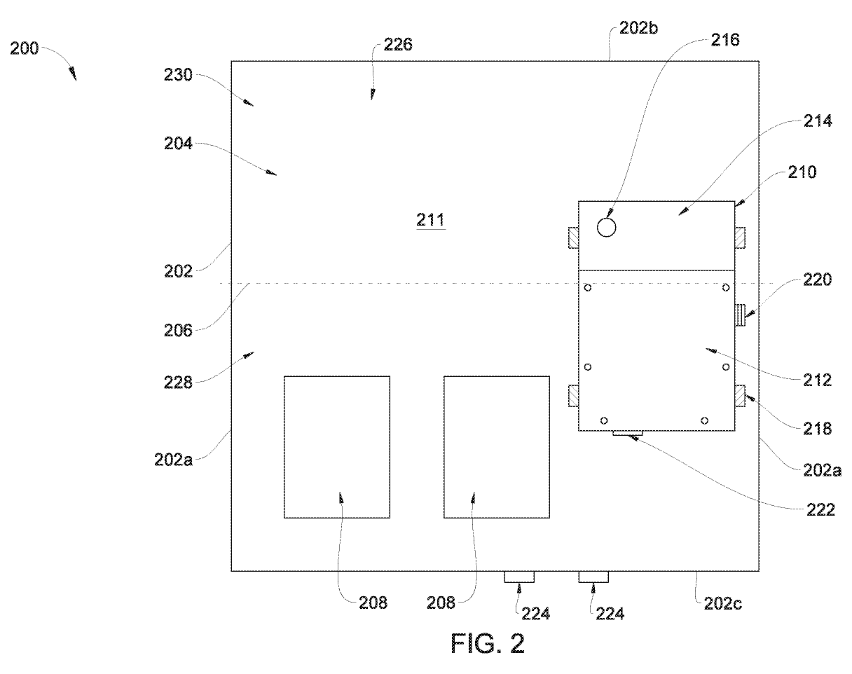

There are, however, many other possible configurations for arranging the HVPS circuitry, and multiple possible ways for adding the encapsulant. Consider, for example, FIG. 2 showing a schematic diagram 200 an example power system placed inside an enclosure 202 (also referred to as a chassis), which may be similar to the enclosure 130 of FIG. 1, into which encapsulant material can be introduced. Additional details regarding the configuration and implementations of a high voltage power supply systems such as the one depicted in FIG. 2 can be found at PCT publication WO 2024/166014, entitled “Electrical isolation and thermal regulation for high voltage electrical components,” the content of which is incorporated herein by reference in its entirety. Briefly, an interior volume 204 of the enclosure may contain a number of electrical components 208, as well as a high voltage component isolation casing 210. Any of the electrical components 208, high voltage component casing 210 (or the high voltage components, such as voltage conversion circuitry that can include high-power switching devices, coiled voltage transformers, etc., that are disposed in the casing) may be secured to one or more printed circuit board assemblies such as PCB 211 that is disposed in the enclosure. In FIG. 2, the location of the PCB 211 is depicted generally within the interior volume 204 of the enclosure. The electrical components 208, the high voltage casing 210, and components located in the high voltage casing 210 may be secured directly to the PCB 211 (e.g., through soldering, fasteners such as screws, adhesives, etc.). The high voltage component casing 210 includes a removable face cover 212 and a removable access cover 214. The high voltage component casing 210 may define a vent opening 216, that in this example is formed in the access cover 214. Further features of the high voltage component casing 210 includes one or more heating elements 218 and a temperature sensor 220. The high voltage component casing 210 further defines an encapsulant inlet 222, which in examples, may be an opening in wall of the casing 210. Other electrical connections 224 may penetrate various walls of the enclosure 202, such as the bottom wall 202c, though these penetrations may be sealed.

The dashed line 206 defines a level to which the enclosure 202 may be filled with encapsulant so as to isolate the desired high voltage components of a power supply circuit, as well as other components. The encapsulant can also be used to bond, and thus mount, the HVPS circuitry implemented by the combination of the electrical component 208, the casing 210, the components in the casing 210, and the PCBA 211, to the flange 120 of FIG. 1 (which in turn allows the secure and safe placement of an HVPS in close proximity to a vacuum chamber and the components disposed therein). In some examples, encapsulant is introduced into the enclosure 202 at, for example, a port marked 202b, resulting in the pouring of the encapsulant in a direction marked with arrow 226. Sufficient encapsulant may be poured until a level corresponding to the line 206 (or at some other level) is reached. This results in a filled volume 228 and an unfilled volume 230. In embodiments in which the casing 210 is also to be filled with encapsulant material (in order to inhibit electrical discharge as a result of the high voltage operation within the casing), as the encapsulant is being introduced to the interior volume 204 of the enclosure 202, flowable encapsulant enters the high voltage component casing 210, for example, via the encapsulant inlet 222. Air present within the interior volume of the high voltage component casing 210 flows out of the vent opening 216. As such, an interior volume of the high voltage component casing 210 also fills, when needed, with encapsulant.

Other structural configurations for arranging the HVPS circuitry and for introducing the insulating encapsulant into the space occupied by at least a portion of the HVPS circuitry mounted on the exterior surface of the vacuum flange can also be used.

As described herein, the integrated HVPS and vacuum flange assembly depicted in FIG. 1 can be used to provide high voltage power to, for example, vacuum chambers of mass spectrometry systems. To illustrate, reference is made to FIG. 3 providing a schematic diagram of an example mass spectrometry (MS) system 300 depicting a multi-sectional mass spectrometry system configuration that is fitted with one or more of the integrated HVPS and vacuum flange assemblies described herein. The example implementations of FIG. 3 include, for illustration purposes, two components of a mass analyzer 360 (namely a liner 362 and a detector 364) with integrated HVPS and vacuum flange assemblies 366 and 368 in which the HVPS circuitries for powering the liner 362 and the detector 364 are positioned directly on vacuum flanges that fit in openings of the housing(s) to seal the housing in order to establish vacuum conditions. The assemblies can be pre-fabricated and easily fitted (and if needed, bonded) to the housing(s). While FIG. 3 shows only two components with the proposed integrated HVPS and flange assemblies, other components and MS sections (and in some embodiments, all sections and components), or fewer sections of the MS system 300 (including one or more of the ion source, the QJet, Q0, Q1, ECD cell, Q2 and any of the components of the mass analyzer 360) may be implemented with similar integrated HVPS and flange assemblies. It should also be noted that embodiments of the proposed framework are not restricted to the MS system of FIG. 3 but may be implemented with any type of mass spectrometer, having different sectional configurations (with different electrode set arrangements), and with different types of mass spectrometer analyzers. In some embodiments, the MS system may include fewer sections and/or components than those illustrated in FIG. 3, and/or may include some other components / sections that are not specifically depicted in FIG. 3. Additionally, the integrated HVPS and vacuum flange assemblies can be used with other types of systems (e.g., medical imaging systems, etc.).

As depicted in FIG. 3, the MS system 300 includes an ion source 302 for generating a plurality of ions. Some examples of suitable ion sources can include, without limitation, an electrospray ionization device, a nebulizer assisted electrospray device, a chemical ionization device, a nebulizer assisted atomization device, a chemical ionization device, an atmospheric pressure chemical ionization (APCI) device, a heated nebulizer device, a thermal desorption ion source, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The QJet (or alternatively a DJet) is a Sciex-manufactured high pressure ion guide for collimating the ion beam in the first stage(s) of the ion rail. The purpose of the QJet (or DJet) is to capture and control the ions entering with the gas through the orifice and hold the ions within the ion path as the gas is evacuated. In the front end of the QJet, or DJet, there is a physical transport component. The QJet optic can thus capture and focus the ions using a combination of gas dynamics and radio frequency fields. In some embodiments, the ions produced by the ion source 302 may undergo some initial processing, e.g., ion declustering operations that are performed by a curtain chamber (not shown in FIG. 3) positioned upstream of the QJet section 310. Such a curtain chamber can provide a curtain gas flow (e.g., of N₂) to help keep the downstream sections of the MS system clean by declustering and repelling large neutral particles.

The ions travelling through the QJet section 310 are transmitted via an ion lens IQ0 322 into an ion guide Q0 320, which includes four rods (two of which are visible in this figure) that are arranged in a quadrupole configuration to form an ion beam for transmission to downstream components of the mass spectrometer. In various embodiments, other multipole configurations, such as a hexapole or an octupole configuration, can be utilized in place of the quadrupole configuration.

It is noted that the first two stages described in relation to FIG. 3, namely the QJet and Q0, are optional stages, and that the MS system 100 may be realized without these stages, or may include additional stages and special multipole electrodes, following the orifice, to overcome the gas dynamics and/or physical transport aspects of mass spectrometry. It is also noted that the various upstream lenses and stages (such as IQ0, Q0, which are designed and manufactured by Sciex) may not be included in some mass spectrometry systems.

An ion beam exits the Q0 ion guide 320 and is focused through an ion lens IQ1 332 (optionally with a quadrupole prefilter lens ST1 334) into an ion mass filter 330 (Q1), which includes four rods (two of which are visible in this figure) that are arranged in a quadrupole configuration and to which RF voltages as well as a DC resolving voltage can be applied for radially focusing the ions and selecting ions having a target m/z ratio or lying within some m/z range of interest as they pass through the Q1 mass filter. In the embodiments of FIG. 3, the Q0 ion guide and the Q1 mass filter may be disposed in differentially pumped vacuum chambers. By way of example, the vacuum chamber of Q0 320 can be maintained at a pressure in a range of about 3 to about 12 mTorr, and the vacuum chamber of Q1 330 can be maintained at a pressure in a range of about 1 to about 50 µTorr.

The ions passing through the Q1 can optionally be focused via a quadrupole pre-filter lens ST2 336 and an ion lens IQ2A into an ECD section 340 and subsequently into a Q2 ion trap 350. The ion trap 350 is configured to controllably eject ions (through controlled application of RF and/or DC voltages to the multipole rods of the ion trap 350) in a desired sequence. For example, ions may be ejected in order of the m/z ratio with heaviest ions (i.e., ions with a high m/z ratio) ejected first, and the lightest ions (i.e., ions with a low m/z ratio) ejected last. Other ejection sequences can also be used. Further details regarding ion traps, and approaches for controlling such ion traps, are provided in US 7,456,388, entitled “Ion guide for mass spectrometer,” the content of which is incorporated herein by reference in its entirety.

Ions exiting the ion trap are received, in some embodiments, by a downstream time-of-flight mass analyzer 360 and are separated (e.g., based on their m/z ratios) for detection via an ion detector 364. The time-of-flight mass analyzer of the example embodiments of FIG. 3 includes an accelerator, mirrors and liner sections (the liner of FIG. 3 is marked with reference numeral 362) used to guide the ions received from the Q2 section towards the detector, and separate the ions based on their flight time. An analysis module (which may be implemented using the controller 380, and/or the terminal 384 of the controller 380) is in communication with the ion detector 364 to receive ion detection signals (e.g., electrical pulses) generated by the ion detector 364, and to process and analyze those signals (e.g., to generate a mass spectrum of the detected ions).

As further illustrated in FIG. 3, at least some of the components of the mass analyzer 360, namely the liner 362 and the detector 364, can be powered with RF/DC high voltages generated with respective integrated HVPS and vacuum flange assemblies 366 and 368 (and controlled either by the controller 380 or by a local controller situated on one or more of the PCBA’s included in the assemblies 366 and/or 368) that are each similar to the integrated assembly 110 of FIG. 1. In the example of FIG. 3, HVPS circuitries housed in the assemblies 366 and 368 (and shown within a shaded area representing an encapsulant) receive RF and DC power from remote RF/DC voltage sources, such as the RF/DC voltage sources 370, at pre-determined base voltage levels (e.g., DC voltages for the quadrupole arrangements are provided at voltage levels of up to 800 V, while RF power sources are typically at levels of less than 200 Vrms). At least part of the HVPS circuitry encased / embedded in each of the encapsulants in the assemblies 366 and 368 converts the received RF and/or DC voltages to the voltage levels needed to power and operate the respective components of the MS analyzer 360 and to control the pressure within the housing of the mass analyzer 360. As shown in FIG. 3, the assemblies 366 and 368 include a flange represented as the black base protruding into the inner volume of the housing of the mass analyzer 360. Prior to initial operation of the MS system 300, the flange and the structure comprising the HVPS circuitry of the assemblies 366 and 368 are fitted into openings in the housing of the mass analyzer 360 to seal the housing in order to allow proper establishment of a vacuum environment in the mass analyzer 360. It is noted that the flange can be constructed from strong and durable materials that allow one or more of the mass analyzer components to be attached to (e.g., suspended from) the flange. In such embodiments, the direct connection of the mass analyzer components to the vacuum flange also allows for direct electrical connection of the MS analyzer components to the electrical conductors (carrying the high voltage power produced by the HVPS circuitry) through the flange (e.g., via ports which may include feedthrough structures).

Although the schematic of the MS system 300 includes a single housing for the MS analyzer 360 with two assemblies 366 and 368, in some embodiments, the mass analyzer 360 can be constituted through multiple housings that house one or more of the mass analyzers components (e.g., optics, accelerators, detectors, etc.) It is also noted that each of the illustrated mass analyzer components may be electrically coupled to a dedicated integrated HVPS and vacuum flange assembly, or that all the components housed in the depicted housing of the mass analyzer 360 may be powered by a single integrated HVPS and vacuum flange assembly (such as the assembly 366 or 368).

The RF/DC voltage sources 370 operating under the control of the controller 380 can apply the requisite RF and DC voltages to various components of the mass spectrometry system 300, including the components of the QJet, Q0, Q1, Q2, and the mass analyzer (and optionally to the ion source 302). In FIG. 3, the RF/DC voltage sources 370 are shown directly powering the QJet, Q0, Q1, the ECD cell, and Q2, and thus delivering high voltage power to them (when such high voltage power is required). The RF/DC voltage sources 370 are also shown delivering power to the assemblies 366 and 368, with the assemblies’ circuitries converting the received power into power levels required to operate the liner 362 and the detector 364. The RF/DC voltage sources 370 may be connected to all the various electrodes and components of the mass spectrometry system 300. In some embodiments, due to high voltage requirements by quadrupole sections (such as Q1 and Q2), the RF/DC voltage sources 370 may power these sections via resonant coils. However, in situations where required voltage levels and voltage characteristics for one or more sections of the MS system 300 are such that the integrated HVPS and vacuum flange assemblies can be used, one or more such integrated assemblies may be fitted into openings in respective housings of the sections (e.g., QJet and/or Q0) to power the components of those sections.

Although only one module of RF/DC sources is shown in FIG. 3, multiple RF and DC sources may be used in embodiments of the mass spectrometry system 300. For example, each of the various sections of the mass spectrometry system 300 may have its own dedicated RF and DC source (as well as, optionally, a dedicated controller) to implement independent voltage control for each of those sections (e.g., the rods of the QJet, Q0, Q1, Q2, and the mass analyzer).

As further illustrated in FIG. 3, the MS system may further include a user-interface 384, that would typically include an input user interface (such as a keyboard, a mouse, dedicated controls and buttons) to interact with the MS system 300 in order to, for example, configure the system, provide input instructions, etc. The user interface 384 may also include an output user interface (such as a display device), coupled to the controller 380 and/or the analysis module, to receive analysis results and other output produced by the MS system 300.

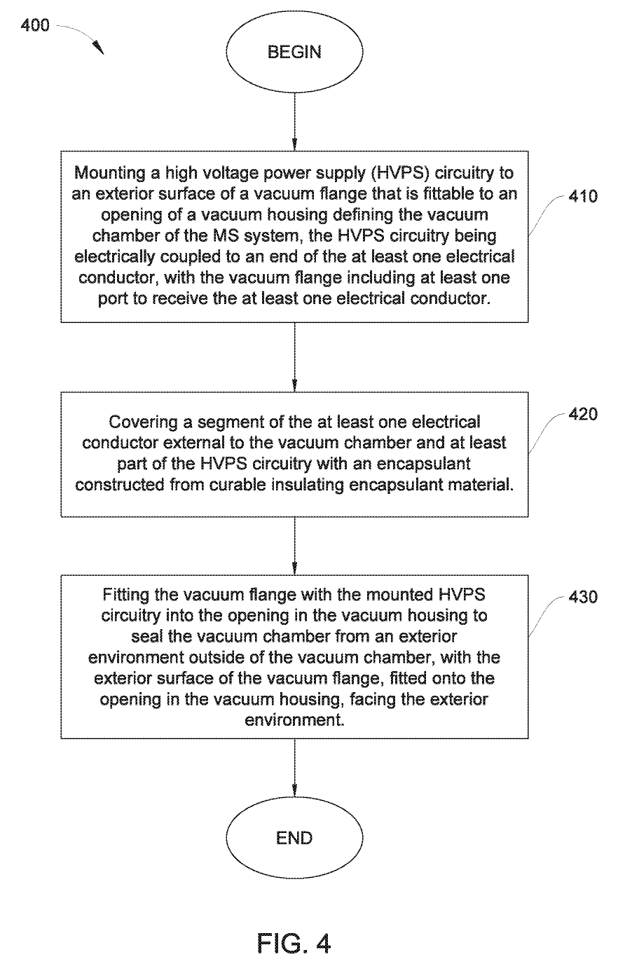

With reference next to FIG. 4, a flowchart of a procedure 400 for coupling a power system to a vacuum chamber of a mass spectrometry (MS) system is shown. Aspects of the procedure 400 include the coupling of an integrated HVPS and vacuum flange assembly to a vacuum chamber of an analytical system (such as a mass spectrometry system) and fabrication operations to construct the integrated assembly. Thus, the procedure 400 includes mounting 410 a high voltage power supply (HVPS) circuitry (e.g., the PCBA’s 140a-b and 142 depicted in FIG. 1) to an exterior surface of a vacuum flange (e.g., flange 120 of FIG. 1) that is fittable to an opening (e.g., the opening 164) of a vacuum housing (e.g., the vacuum housing 162) defining a vacuum chamber of a section of the MS system (an MS system such as the system 300 of FIG. 3). The HVPS circuitry is electrically coupled to an end of the at least one electrical conductor, with the vacuum flange including at least one port (such as the port through which example feedthroughs 114a-b are fitted) to receive the at least one electrical conductor (such as the conductors 112a and 112b depicted in FIG. 1).

The procedure 400 further includes covering 420 a segment of the at least one electrical conductor external to the vacuum chamber and at least part of the HVPS circuitry with an encapsulant constructed from a curable insulating encapsulant material. As discussed herein, an encapsulant material, in liquid form, is introduced (using a removable mold, or the shape of an enclosure in which the HVPS circuitry is disposed) to cover at least a portion of the HVPS circuitry (e.g., the PCBA’s 140a-b) and the portions of electrical conductors 112a-b (e.g., conductive pins or wires) that are external to the vacuum chamber (e.g., the vacuum chamber after it has been sealed by the vacuum flange on which the HVPS circuitry is mounted). Accordingly, in some examples, electrical conductors, such as the conductors 112a-b that lead from the output of the HVPS circuitry to at least the ports of the vacuum flange are covered in encapsulant, thus allowing the use of normal conductors (instead of, for example, expensive power cables) and a reduction in the risk of electrical discharge issues. In some examples, the covering of the electrical conductors can extend to points beyond the entrance to the ports on the exterior surface of the flange. During the introduction of liquid encapsulant, processes to remove air bubbles that may be in the liquid encapsulant may be applied (e.g., by pouring the liquid encapsulant in vacuum conditions).

In various examples, mounting the HVPS circuitry to the vacuum flange and covering the segment of the at least one electrical conductor and the at least part of the HVPS occur prior to the fitting of the vacuum flange into the opening in the vacuum housing. For example, the assembly comprising the vacuum flange and the HVPS circuitry mounted onto the flange can be first fabricated (including the covering of at least part of the HVPS circuitry and electrical conductors that would be external to the vacuum chamber). The assembly, once fabricated is fitted (by hand, using tools, or in some automated fashion) into an opening in the housing of the vacuum chamber, to seal the vacuum chamber. In some examples, the vacuum flange can include an interior surface, opposite the exterior surface, that when fitted onto the opening in the vacuum housing, the interior surface faces the vacuum chamber.

In some examples, mounting the HVPS circuitry to the vacuum flange can include mounting an enclosure (such as the enclosure 130 of FIG. 1) for housing the at least one electrical conductor and the HVPS circuitry to the exterior surface of the vacuum flange. In various embodiments, covering the segment of the at least one electrical conductor external to the vacuum chamber and the at least part of the HVPS circuitry with the encapsulant can include pouring liquid form of the encapsulant material into a removable or permanent mold to cover the segment of the at least one electrical conductor external to the vacuum chamber and the at least part of the HVPS circuitry. Covering the segment of the at least one electrical conductor external to the chamber and at least part of the HVPS circuitry with the encapsulant can include pouring liquid form of the encapsulant material into an inner volume of the enclosure containing the segment of the at least one electrical conductor external to the vacuum chamber and the at least part of the HVPS circuitry.

With continued reference to FIG. 4, the procedure 400 further includes fitting 430 the vacuum flange with the mounted HVPS circuitry into the opening in the vacuum housing to seal the vacuum chamber from an exterior environment outside of the vacuum chamber, with the exterior surface of the vacuum flange, fitted into the opening in the vacuum housing, facing the exterior environment.

In some embodiments, mounting the HVPS circuitry to the exterior surface of the vacuum flange can include mounting the HVPS circuitry to the exterior surface of the vacuum flange and covering at least a portion of the HVPS circuitry with the encapsulant to form an exterior assembly, and fitting the exterior assembly to the opening defined in the vacuum housing.

Depending on certain implementation requirements, embodiments of the invention (e.g., to control the fabrication process of the integrated HVPS and vacuum flange assembly) can be implemented in hardware and/or in software. In some examples, the fabrication process of the integrated HVPS and vacuum flange assembly can be automated through use of a robotic system to perform one or more of the operations of manufacturing the integrated HVPS and vacuum flange assembly. For example, such a robotic system may include controllable actuatable elements for mounting the HVPS circuitry to the exterior surface of a vacuum flange, automatically pouring encapsulant material from a moveable robotic spout into a mold or an enclosure housing the HVPS circuity, transporting the flange with the mounted and encapsulated circuitry into an opening of a vacuum chamber housing, etc. In some examples, at least some portions of the integrated HVPS and vacuum flange assembly may be constructed using 3-D printing processes.

In various embodiments, the implementations involving the manufacturing of the integrated HVPS and vacuum flange assembly can be performed under the control of a processor-based device with access to non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Those having ordinary skill in the art will appreciate that various changes can be made to the above embodiments without departing from the scope of the present teachings.

What is claimed is:

1. A mass spectrometer power system comprising:
a vacuum flange configured to be fitted to an opening of a vacuum housing, defining a vacuum chamber of the mass spectrometer, to seal the vacuum chamber from an exterior environment, wherein the vacuum flange includes an exterior surface facing the exterior environment, and an interior surface facing the vacuum chamber, and wherein the vacuum flange includes at least one port configured to provide a passageway for at least one electrical conductor;
a high voltage power supply (HVPS) circuitry mounted to the vacuum flange on the exterior surface of the vacuum flange and electrically coupled to an end of said at least one electrical conductor extending from the at least one port; and
an encapsulant, constructed from a curable insulating encapsulant material, surrounding a segment of said at least one electrical conductor external to said vacuum chamber and at least a part of the HVPS circuitry.

2. The power system of claim 1, wherein the at least one port of the vacuum flange includes at least one feedthrough to receive said at least one electrical conductor.

3. The power system of claim 1, further comprising one or more mass spectrometry components positioned in said vacuum chamber.

4. The power system of claim 3, wherein the one or more mass spectrometry components are mounted to the interior surface of the vacuum flange, the one or more mass spectrometry components including one or more of: ion optics components, one or more detector elements, or one or more printed circuit boards.

5. The power system of claim 1, wherein the HVPS circuitry comprises one or more printed circuit boards (PCB’s) comprising circuitry to receive power from a power source, and to produce high voltage power for application to components within the vacuum chamber via the at least one electrical conductor.

6. The power system of claim 1, wherein the encapsulant comprises:
at least one integral vacuum feedthrough, wherein the one or more integral vacuum feedthroughs are constructed from the insulating encapsulant material, and wherein the integral vacuum feedthroughs include the at least one conductor passing through the at least one port in the vacuum flange.

7. The power system of claim 1, further comprising an enclosure, coupled to the exterior surface of the vacuum flange, in which the HVPS circuitry is disposed, wherein the enclosure is one of: a shielding enclosure, or an insulating enclosure.

8. The power system of claim 7, wherein the encapsulant is bonded to at least part of the exterior surface of the vacuum flange and to part of the enclosure, wherein the power system further comprises an inner container disposed within the enclosure, wherein the HVPS circuitry is disposed in the container, and wherein the encapsulant is bonded to at least part of the exterior surface of the vacuum flange and to part of the container.

9. The power system of claim 7, further comprising one or more of:
a conductive dividing shield within the enclosure separating the encapsulant from at least a part of an inner volume of the enclosure, or
a seal, disposed between the enclosure and the exterior surface of the vacuum flange, to prevent leakage of liquid-form encapsulant material prior to curing of liquid-form of the encapsulant material.

10. The power system of claim 7, wherein the encapsulant is shaped to substantially conform to a shape of at least a portion of an inner volume of the enclosure in which the encapsulant is disposed.

11. The power system of claim 7, wherein the encapsulant is shaped according to a removable or permanent mold for receiving liquid-form of the encapsulant material, wherein the mold is disposed in an inner volume of the enclosure and bonded to the vacuum flange.

12. The power system of claim 1, wherein the encapsulant is a dielectric encapsulant.

13. The power system of claim 1, wherein the encapsulant is shaped according to a removable or permanent mold for receiving liquid-form of the encapsulant material, wherein the mold surrounds the segment of the at least one electrical conductor external to the vacuum chamber and the at least a part of the HVPS circuitry, and wherein the exterior surface of the vacuum flange is free of structures surrounding the encapsulant.

14. The power system of claim 1, further comprising:
the vacuum chamber defined by the vacuum housing including the opening.

15. A method for coupling a power system to a vacuum chamber of a mass spectrometry (MS) system, the method comprising:
mounting a high voltage power supply (HVPS) circuitry to an exterior surface of a vacuum flange that is fittable to an opening of a vacuum housing defining the vacuum chamber of the MS system, the HVPS circuitry being electrically coupled to an end of at least one electrical conductor, wherein the vacuum flange includes at least one port to receive the at least one electrical conductor;
covering a segment of the at least one electrical conductor external to the vacuum chamber and at least part of the HVPS circuitry with an encapsulant constructed from curable insulating encapsulant material; and
fitting the vacuum flange with the mounted HVPS circuitry into the opening in the vacuum housing to seal the vacuum chamber from an exterior environment outside of the vacuum chamber, wherein the exterior surface of the vacuum flange, fitted into the opening in the vacuum housing, faces the exterior environment.

16. The method of claim 15, wherein mounting the HVPS circuitry to the vacuum flange and covering the segment of the at least one electrical conductor and at least part of the HVPS circuitry, occur prior to the fitting of the vacuum flange into the opening in the vacuum housing.

17. The method of claim 15, wherein covering the segment of the at least one electrical conductor external to the vacuum chamber and the at least part of the HVPS circuitry with the encapsulant comprises:
pouring liquid form of the of the encapsulant material into a removable or permanent mold to cover the segment of the at least one electrical conductor external to the vacuum chamber and the at least part of the HVPS circuitry.

18. The method of claim 15, wherein mounting the HVPS circuitry to the vacuum flange comprises:
mounting an enclosure for housing the at least one electrical conductor and the HVPS circuitry to the exterior surface of the vacuum flange.

19. The method of claim 18, wherein covering the segment of the at least one electrical conductor external to the chamber and at least part of the HVPS circuitry with the encapsulant comprises:
pouring liquid form of the encapsulant material into an inner volume of the enclosure containing the segment of the at least one electrical conductor external to the vacuum chamber and the at least part of the HVPS circuitry.

20. The method of claim 15, wherein mounting the HVPS circuitry to the exterior surface of the vacuum flange comprises:
mounting the HVPS circuitry to the exterior surface of the vacuum flange and covering at least a portion of the HVPS circuitry with an encapsulant to form an exterior assembly; and
fitting the exterior assembly to the opening defined in the vacuum housing.
